(19) United States
(12) Patent Application Publication
(10) Pub. No.: US 2023/0228444 A1
(43) Pub. Date: Jul. 20, 2023

(54) DETERMINING PATTERNS AS ACTIONABLE INFORMATION FROM SENSORS IN BUILDINGS

(71) Applicant: Carrier Corporation, Palm Beach Gardens, FL (US)

(72) Inventors: Ziyou Xiong, Wethersfield, CT (US); Michael J. Birnkrant, Wethersfield, CT (US); Marcin Piech, East Hampton, CT (US); Sotiri Tolis Hovardas, Pittsboro, IN (US); Peter McKinney, Boulder, CO (US); Emily Yang, Shanghai (CN)

(21) Appl. No.: 18/156,781

(22) Filed: Jan. 19, 2023

Related U.S. Application Data
(60) Provisional application No. 63/301,137, filed on Jan. 20, 2022.

(51) Int. Cl. F24F 11/63; F24F 11/30

(52) U.S. Cl. CPC F24F 11/63; F24F 11/30; F24F 2110/70

(57) ABSTRACT

A system and method for identifying patterns of indoor air quality sensors. A method includes receiving sensor data from a sensor to determine indoor air quality, the sensor including indoor air quality (IAQ) sensors and identifying a pattern of the sensor data for a period of time. The method may also include comparing current sensor data to the identified pattern of the sensor data and transmitting a message to a user device based at least in part on the comparison to indicate the indoor air quality and the pattern of the sensor data.

### CROSS-REFERENCE TO RELATED APPLICATIONS

This application claims the benefit of U.S. Provisional Application No. 63/301,137 filed Jan. 20, 2022, all of which are incorporated herein by reference in their entirety.

### BACKGROUND

The present disclosure relates to building management, and more specifically, to a system and method for determining patterns as actionable information from sensors in healthy buildings.

Heating, ventilation, and air conditioning (HVAC) systems are historically operated according to a fixed schedule during different periods of the day. For example, buildings may turn the HVAC equipment on during normal working hours (when workers are typically present) and off outside of the normal working hours to conserve resources and cost. Recent developments have provided building owners and managers more and easier access to real-time data (incl. occupancy levels). However, this real-time can become overwhelming and unhelpful to building owners and managers when provided in an unprocessed, non-actionable format.

### BRIEF DESCRIPTION

According to an embodiment, a system for identifying patterns of indoor air quality is provided. The system includes a plurality of sensors, wherein the plurality of sensors comprises indoor air quality (IAQ) sensors; and a controller communicatively coupled to the plurality of sensors. The controller can be configured to receive sensor data from a sensor of the plurality of sensors to determine indoor air quality; identify a pattern of the sensor data for a period of time; compare current sensor data to the identified pattern of the sensor data; and transmit a message to a user device based at least in part on the comparison to indicate the indoor air quality and the pattern of the sensor data.

In addition to one or more of the features described herein, or as an alternative, further embodiments include a controller that is configured to use a machine learning algorithm to identify the pattern.

In addition to one or more of the features described herein, or as an alternative, further embodiments include a controller that is configured to receive sensor data from the plurality of sensors; and identify a plurality of patterns for each of the plurality of sensors, respectively.

In addition to one or more of the features described herein, or as an alternative, further embodiments include a controller that is configured to determine a correlation between each of the plurality of patterns; and increase a confidence interval based on the correlation.

In addition to one or more of the features described herein, or as an alternative, further embodiments include IAQ sensors that are configured to detect one or more of: a CO2 level, a particulate matter level, and a humidity level.

In addition to one or more of the features described herein, or as an alternative, further embodiments include a controller that is configured to control a heating, ventilation, and air conditioning (HVAC) system responsive to the comparison.

In addition to one or more of the features described herein, or as an alternative, further embodiments include a controller that is configured to automatically operate the HVAC system if the current reading is within the identified pattern.

In addition to one or more of the features described herein, or as an alternative, further embodiments include a controller that is configured to inhibit operating the HVAC system if the current reading falls outside of the identified pattern; and provide an indication of the current reading that falls outside of the identified pattern to the user device.

According to another embodiment, a method for identifying patterns of indoor air quality sensors is provided. The method comprising: receiving sensor data from a sensor to determine indoor air quality, wherein the sensor comprises indoor air quality (IAQ) sensors; identifying a pattern of the sensor data for a period of time; comparing current sensor data to the identified pattern of the sensor data; and transmitting a message to a user device based at least in part on the comparison to indicate the indoor air quality and the pattern of the sensor data.

In addition to one or more of the features described herein, or as an alternative, further embodiments include using a machine learning algorithm to identify the pattern.

In addition to one or more of the features described herein, or as an alternative, further embodiments include receiving sensor data from a plurality of sensors; and identifying a plurality of patterns for each of the plurality of sensors, respectively.

In addition to one or more of the features described herein, or as an alternative, further embodiments include determining a correlation between each of the plurality of patterns; and increasing a confidence interval based on the correlation.

In addition to one or more of the features described herein, or as an alternative, further embodiments include IAQ sensors that are configured to detect one or more of: a CO2 level, a particulate matter level, and a humidity level.

In addition to one or more of the features described herein, or as an alternative, further embodiments include controlling a heating, ventilation, and air conditioning (HVAC) system responsive to the comparison.

In addition to one or more of the features described herein, or as an alternative, further embodiments include automatically operating the HVAC system if the current reading is within the identified pattern.

In addition to one or more of the features described herein, or as an alternative, further embodiments include inhibiting operating the HVAC system, if the current reading falls outside of the identified pattern; and providing an indication of the current reading that falls outside of the identified pattern to the user device.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 illustrates a block diagram of an exemplary system comprising a plurality of sensors in accordance with one or more embodiments of the disclosure;

FIG. 2 illustrates exemplary node of FIG. 1 in accordance with one or more embodiments of the disclosure;

FIG. 3 illustrates a graph representing example sensor readings that are obtained in accordance with one or more embodiments of the disclosure;

FIG. 4 illustrates a plurality of graphs representing sensor readings that are obtained in accordance with one or more embodiments of the disclosure; and

FIG. 5 illustrates a flowchart of an exemplary method for monitoring and determining trends for air quality of an indoor space in accordance with one or more embodiments of the disclosure.

### DETAILED DESCRIPTION

Buildings are often equipped with various sensors for detecting conditions that can be used to control HVAC systems. For example, buildings may include thermometers, humidity detectors, etc. As time progresses the measured sensors readings may begin to show patterns that may be analyzed and leveraged for optimal control. The determined patterns based on the historical sensor readings can be presented to the building owners or managers so they can manually control the HVAC system, or the patterns can be used to directly control the building HVAC system and equipment to achieve a desired building health level. The techniques of one or more embodiments described herein alleviate the need for the building owners and managers to perform the tedious and complex control work for managing the indoor air quality. Instead, the building owners and managers can provide high-level input to guide the automatic controllers to manage the building health.

The control scheme provided herein may be configured to operate the ventilation/HVAC equipment during abnormal time periods, instead of being manually operated or operated on a fixed schedule. The control scheme provided herein may reduce the number of times that the HVAC equipment switches on/off, which can result in significant energy savings. Also, the control scheme provided herein can deliver improved accuracy and control over the HVAC system. Since the determined data patterns are summarized over many days (or other configurable time periods) and the noise in hour-level or minute-level is reduced, the HVAC system control will be based on patterns that have been determined over days, instead of instantaneous using instantaneous data for HVAC system control. In one or more embodiments of the techniques described herein, sensor readings that are detected within the expected range or threshold of a determined pattern can be readily accepted to control the operation of the HVAC system while readings that fall outside of the expected range or threshold of the pattern can undergo additional processing to verify the correct reading. Therefore, the techniques described herein result in more accurate control of the HVAC system, and optimal building health can be achieved.

A detailed description of one or more embodiments of the disclosed apparatus and method are presented herein by way of exemplification and not limitation with reference to the Figures.

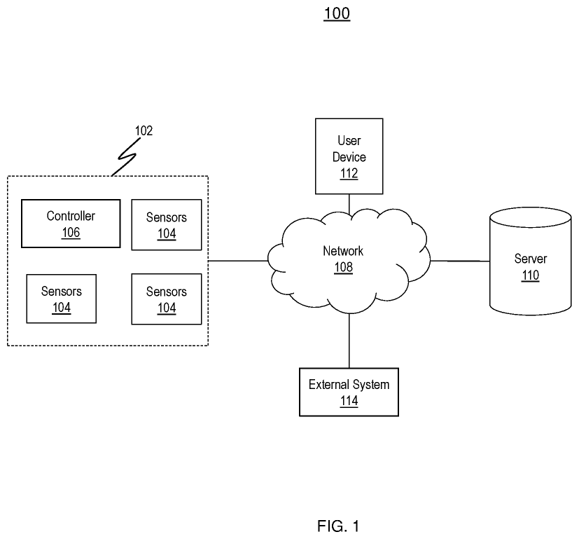

Now referring to FIG. 1, a block diagram of an exemplary system 100 for monitoring indoor air quality in accordance with one or more embodiments of the disclosure is provided. A space 102 can be equipped with a plurality of sensors 104 to monitor various conditions that are indicative of air quality such as but not limited to humidity, CO2 levels, temperatures, particulate matter, etc. The space 102 may be a room, an office space, a conference, or some other defined space. The sensors 104 may be configured to communicate sensor data to a controller 106 or may communicate over a network 108. The controller 106 can be configured to communicate with the sensors 104 and can be further configured to provide control signals to operate HVAC equipment to manage the air quality of the controlled space 102.

The network(s) 108 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

It should be understood the controller 106 may be configured to manage multiple spaces 102 and is not limited to the single space shown in FIG. 1. The controller 106 can also be configured to communicate with the server 110 over the network 108 using any suitable communication medium and protocol. The controller 106 and/or the server 110 can store the sensor data and perform an analysis of the sensor data to determine a pattern in the air quality for the monitored space.

The controller 106 and/or the server 110 can be configured to provide alerts or notifications to the user device 112 to indicate the condition of the air quality. Also, the status of various HVAC equipment can be provided to the user device 112. In example embodiments, the user device 112 may comprise a smartphone, tablet, laptop, etc. In other embodiments of the disclosure, the system 100 can include an external system 114 that can be configured to communicate with the one or more of the sensors 104, the controller 106, the server 110, or the user device 112 over the network 108.

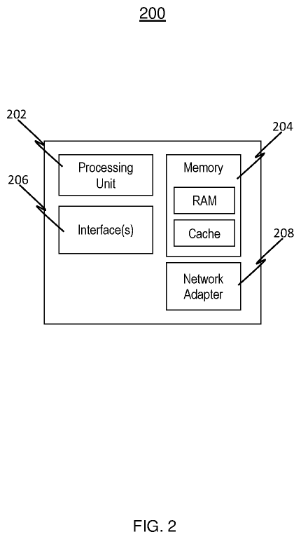

Referring now to FIG. 2, in which an exemplary node 200, representative of any of the sensors 104, the controller 106, and/or the user device 112 of FIG. 1, that is used to implement the embodiments of the present disclosure is shown. Node 200 is only illustrative and is not intended to suggest any limitation as to the scope of use or functionality of embodiments of the invention described herein. As shown in FIG. 2, node 200 is shown in the form of a general-purpose computing device. The components of node 200 may include, but are not limited to, one or more processors 202, a memory 204, interface 206, and network adapter 208. In one or more embodiments of the disclosure, the processor 202 can include a processor 202 of a general-purpose computer, special purpose computer, or other programmable data processing apparatus configured to execute instruction via the processor of the computer or other programmable data processing apparatus.

Nodes 200 can include a variety of computer system readable media. Such media may be any available media that is accessible by node 200, and it includes both volatile and non-volatile media, removable and non-removable media. Memory 204 can include computer system readable media. The memory 204 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), etc.). Node 200 may further include other removable/non-removable, volatile/non-volatile computer system storage media. The processor 202 and a memory 204 are configured to carry out the operations for the nodes. The memory 204 may include one or more program modules (not shown) such as operating system(s), one or more application programs, other program modules, and program data. Each of the operating systems, one or more application programs, other program modules, and program data or some combination thereof, may include an implementation of a networking environment. The program modules generally carry out the functions and/or methodologies of embodiments of the invention as described herein.

Node 200 may also communicate with one or more external devices through the interface 206 such as a keyboard, a pointing device, a display, etc.; one or more devices that enable a user to interact with node 200; and/or any devices (e.g., network card, modem, etc.) that enable node 200 to communicate with one or more other computing devices. Still yet, node 200 can communicate with one or more networks such as a local area network (LAN), a general wide area network (WAN), and/or a public network (e.g., the Internet) via network adapter 208. As depicted, network adapter 208 communicates with the other components of node 200. It should be understood that although not shown, other hardware and/or software components could be used in conjunction with node 200. It can be appreciated the node 200 can include other components or modules and is not limited by the components shown in FIG. 2.

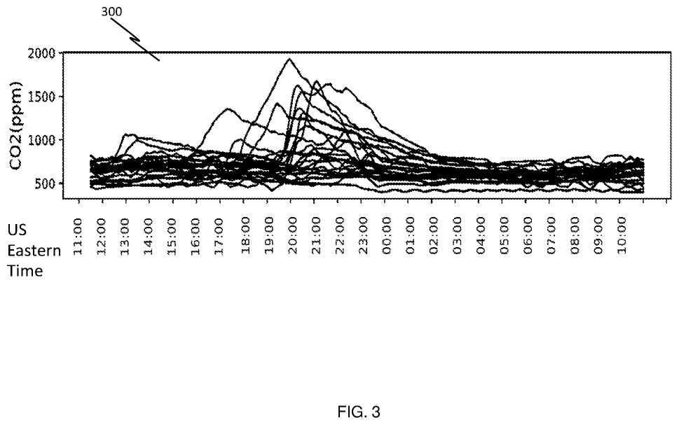

FIG. 3 depicts example sensor readings obtained from a sensor that is part of the system 100 shown in FIG. 1. The x-axis of the graph represents time (in hours) and the y-axis represents values corresponding to the measurement of the sensors. As shown in FIG. 3, multiple sensor readings were obtained using the CO2 sensor over the same period of time. As shown, the CO2 levels are elevated at a time that is approximately between 18:00 and 2:00 with a peak around 20:00 to 22:00. The sensor readings obtained outside of these time periods are substantially constant. Therefore, if an outlier sensor reading is detected outside of the historical trend and or baseline for the CO2 levels, additional scrutiny or analysis can be required prior to controlling the ventilation or HVAC system to improve the indoor air quality. It should be understood that an acceptable air quality can be determined by configuring thresholds that indicate alarm levels of CO2. The threshold can be selected based on the size of indoor space, the airflow in the indoor space, the number of persons in the indoor space, etc.

Machine-learning, which is a type of data analysis that enables systems to learn from data, identify patterns, and make decisions, can be implemented in one or more components in the system 100. The machine learning algorithm may be used to determine patterns and historical which can be used to filter outlier sensor data. In an embodiment of the disclosure, supervised machine learning algorithms can be used which are trained using labeled examples, such as an input where the desired output is known. The machine learning algorithm receives a set of inputs along with the corresponding correct outputs, and the algorithm learns by comparing its actual output with correct outputs to find errors. It then modifies the model accordingly. Through methods like classification, regression, prediction and gradient boosting, supervised learning uses patterns to predict the values of the label on additional unlabeled data. Supervised learning may be used in applications where historical data predicts likely future events. In a non-limiting example, the historical data or pattern can be used to predict when a currently detected reading is reliable or not. If the current reading falls within the historical data or pattern it is unlikely the reading is reliable.

Data from sensors can be input in the machine learning algorithm and used to determine a historical baseline for a monitored space. Over a period of time, data can be collected for each of the parameters and various trends may be detected. The period of time may include a time of day, weekday/weekend, seasons, work hours/non-work hours, peak hours/non-peak hours. It should be understood that any period of time can be selected for analysis.

By identifying patterns among sensor data, the sensor data that is received outside of the trends may be further analyzed prior to modifying the operation of the HVAC system. For example, the outlier data may be ignored. In another example, the outlier data if detected a threshold number of times may indicate a shift or change in the pattern. The updated pattern can be used to influence the operation of the HVAC system. Even further, the historical data or pattern for different sensors readings can be determined and cross-correlated with each other to determine stronger relationships for identifying patterns. Overtime, the patterns are updated to reflect the latest character or any changes in patterns for the defined space which provides that most accurate readings for analysis.

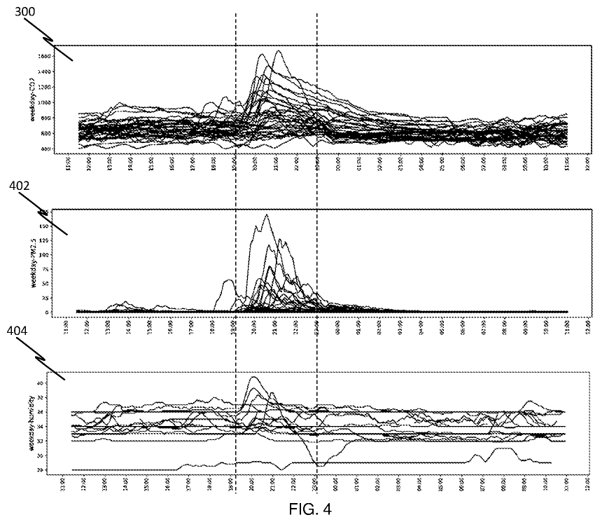

Now referring to FIG. 4, sensor readings from a plurality of sensors 104 are analyzed and displayed in the graphs 300, 402, 404. Graph 300 represents the detected CO2 levels for the defined space, graph 402 represents the detected particulate matter in the defined space, and graph 404 represents the detected humidity in the defined space.

Each of the graphs 300, 402, 404, are collected over the same period which can allow the controller 106, the server 110, or other processor to analyze the sensor data and determine correlations amongst the collected sensor data. Graph 300 was previously described with reference to FIG. 3 above. Graph 402 illustrates an elevation in particulate matter levels and a peak are detected at a time between approximately 19:00 to 23:00; and graph 404 illustrates an elevation in humidity levels and a peak are detected at a time between approximately 19:00 and 22:00.

As illustrated by the dashed lined overlaid on graphs 300, 402, 404, a correlation among the CO2 levels, particulate matter levels, and humidity levels are elevated over approximately the same time between 19:00 and 23:00. The controller 106 or server 110 can determine trends over time for a plurality of conditions and determine correlations between the trends of the plurality of conditions to reliably determine the air quality for the monitored space using machine learning algorithms.

For example, if the CO2 levels indicate an alarm level, and the particulate matter level is increased to level that also indicates an alarm level, a confidence interval for the determined indoor air quality can be increased. Even further, if the humidity level is also elevated during approximately the same period of time, the confidence interval can be further increased. The patterns can be discovered to indicate the indoor air quality condition. In addition, the patterns may reveal a correlation between the HVAC function and the pattern of activity that may be occurring in a room, for example, cooking in the kitchen, having several people or visitors in a room, opening windows at a particular time, etc. Such activities may cause a variation in sensor readings which may reveal a trend. Equipped with such information various mitigation procedures may be employed. For example, if increased particulate matter is detected, the filtration in the area may be implemented; if increase CO2 is detected, ventilation may be triggered; and if VOCs are detected, various filtrations and/or ventilation procedures can be implemented.

In one or more embodiments of the disclosure, the sensor-based pattern recognition and anomaly detection may be further used to infer activities that are occurring in a room/building that are conditioned by the HVAC system. For example, the correlation found from the sensor data in FIG. 4 can provide an indication of cooking events in the room/building within a specific time interval. For example, during an activity of cooking a sudden increase in levels of particle matter are typically generated. If increased levels of particle matter are correlated with particular times of day or days of the week and also occur at a single sensor location, the activity may be classified as cooking within a kitchen area. Confidence score/interval for the classification may be increased by a volatile organic compounds (VOC) sensor also increasing output near the same location. If HVAC equipment is operating in the zone with the sensor and the levels are decreased dramatically, this would indicate a localized source of particulates and/or volatile organic compounds. The duration of the cooking event or other ‘local release’ event could be discerned by observing correlation between HVAC system operation in that zone and decreases/increases in sensor signals. If these events are also well correlated in time through a week or a day they may be classified as ‘cooking’ or similar human impacted activity. Such a detection of a strong correlation may be used as an “interviewing tool” to illustrate/demonstrate to the room/building user/manager the variability of the HVAC power in response to the current activity. For example,

Provided the techniques described herein leverage machine learning algorithms, the trends for each building can be discovered overtime which enables great flexibility over fixed schedules or controlling the HVAC system according to the first detection of a condition, without confirming the reading is not a nuisance or erroneous reading.

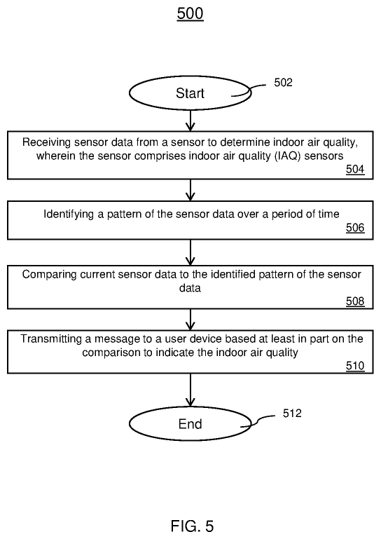

FIG. 5 depicts a flowchart of an exemplary method 500 for discovering patterns and correlating sensor data for building health in accordance with one or more embodiments of the disclosure. Method 500 may be implemented in the system 100 or node 200 shown in FIGS. 1 and 2, respectively, or any other similar type of system. Method 500 begins at block 502 and proceeds to block 504 where the controller 106 or server 110 obtains sensor data from one or more sensors 104. In a non-limiting example, the sensors can include air quality sensors that are in fluid connection with the room or building that is conditioned by the HVAC system. Fluid connection can refer to the airflow between a room and the HVAC system. The fluid connection may be associated with the air convention in the room, the distribution from diffusers, the collection at the return air grill, the transport via duct work and the HVAC unit that includes a fan to move the air. The air quality sensors can be configured to detect humidity, particulates, and temperature. It should be understood that other types of sensors can be used to detect other conditions and/or parameters and is not limited by the examples described herein.

At block 506, the controller identifies a pattern of the sensor data for a period of time. The pattern among sensor data may be identified using machine learning algorithms. In one or more embodiments of the disclosure, the controller is configured to receive sensor data from a plurality of sensors and identify a plurality of patterns for each of the plurality of sensors, respectively. In addition, the controller may be configured to determine a correlation between each of the plurality of patterns and increase a confidence interval based on the correlation.

At block 508, the controller compares current sensor data to the identified pattern of the sensor data. In one or more embodiments, sensors 104 continuously detect the conditions of the indoor air quality and provide the sensor data to controller 106 to compare the historical trend or baseline pattern to the currently detected condition.

At block 510 transmit a message to a user device based at least in part on the comparison to indicate the indoor air quality. If the detected condition falls within the measurement or threshold according to the pattern, the sensor can be reliable. That is, the confidence of the reading can indicate the elevated reading or elevated reading are expected readings based on the pattern determined by the machine-learning algorithm. In some instances, supervised machine learning algorithms can be used. In one or more embodiments of the disclosure, the controller can be configured to control a heating, ventilation, and air conditioning (HVAC) system responsive to the comparison. For example, the controller can automatically operate the HVAC system if the current reading is within the identified pattern, or not operate the HVAC system, if the current reading falls outside of the identified pattern. In such a scenario, the controller may provide an indication of the current reading that falls outside of the identified pattern to the user device.

Method 500 ends at block 512. The process flow diagram of FIG. 5 is not intended to indicate that the operations of method 500 are to be executed in any particular order, or that all of the operations of method 500 are to be included in every case. Additionally, method 500 can include any suitable number of additional operations.

The technical effects and benefits include reducing nuisance alerts and/or inadvertent operation of ventilation/HVAC equipment based on erroneous sensor readings. Therefore, there is no requirement for fixed schedules and more accurate controls of the ventilation/HVAC equipment can be realized based patterns developed from machine learning algorithms using historical data for the space. This enables the system to verify any alarm conditions based on the discovered patterns prior to sending a notification or controlling the operation of the ventilation/HVAC equipment. The technical effects and benefits can also include optimizing the expended resources and power that is consumed by the ventilation/HVAC equipment.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system for identifying patterns of indoor air quality, the system comprising:
a plurality of sensors, wherein the plurality of sensors comprises indoor air quality (IAQ) sensors;
a controller communicatively coupled to the plurality of sensors, the controller is configured to:
receive sensor data from a sensor of the plurality of sensors to determine indoor air quality;
identify a pattern of the sensor data for a period of time;
compare current sensor data to the identified pattern of the sensor data; and
transmit a message to a user device based at least in part on the comparison to indicate the indoor air quality and the pattern of the sensor data.

2. The system of claim 1, wherein identifying the pattern comprises a controller that is configured to use a machine learning algorithm to identify the pattern.

3. The system of claim 1, wherein the controller is further configured to receive sensor data from the plurality of sensors; and
identify a plurality of patterns for each of the plurality of sensors, respectively.

4. The system of claim 3, wherein the controller is further configured to determine a correlation between each of the plurality of patterns; and
increase a confidence interval based on the correlation.

5. The system of claim 1, wherein the IAQ sensors are configured to detect one or more of: a CO2 level, a particulate matter level, and a humidity level.

6. The system of claim 1, wherein the controller is further configured to control a heating, ventilation, and air conditioning (HVAC) system responsive to the comparison.

7. The system of claim 6, wherein controlling the HVAC system comprises the controller configured to automatically operate the HVAC system if the current reading is within the identified pattern.

8. The system of claim 6, wherein controlling the HVAC system comprises the controller configured to:
inhibiting operating the HVAC system if the current reading falls outside of the identified pattern; and
provide an indication of the current reading that falls outside of the identified pattern to the user device.

9. A method for identifying patterns of indoor air quality sensors, the method comprising:
receiving, at a controller, sensor data from a sensor to determine indoor air quality, wherein the sensor comprises indoor air quality (IAQ) sensors;
identifying a pattern of the sensor data for a period of time;
comparing current sensor data to the identified pattern of the sensor data; and
transmitting a message to a user device based at least in part on the comparison to indicate the indoor air quality and the pattern of the sensor data.

10. The method of claim 9, wherein identifying the pattern comprises using a machine learning algorithm to identify the pattern.

11. The method of claim 9, further comprising receiving sensor data from a plurality of sensors; and
identifying a plurality of patterns for each of the plurality of sensors, respectively.

12. The method of claim 11, further comprising determining a correlation between each of the plurality of patterns; and
increasing a confidence interval based on the correlation.

13. The method of claim 9, wherein the IAQ sensors are configured to detect one or more of: a CO2 level, a particulate matter level, and a humidity level.

14. The method of claim 9, further comprising controlling a heating, ventilation, and air conditioning (HVAC) system responsive to the comparison.

15. The method of claim 9, wherein controlling the HVAC system comprises automatically operating the HVAC system if the current reading is within the identified pattern.

16. The method of claim 9, wherein controlling the HVAC system comprises inhibiting operating the HVAC system, if the current reading falls outside of the identified pattern; and
providing an indication of the current reading that falls outside of the identified pattern to the user device.
